(19) United States
(12) Patent Application Publication
(10) Pub. No.: US 2003/0187956 A1
(43) Pub. Date: Oct. 2, 2003

(54) Method and apparatus for providing access control and content management services

(76) Inventors: Stephen Belt, Tracy, CA (US); Amar Chahal, Fremont, CA (US)

Correspondence Address: WOLFF & SAMSON, P.C., ONE BOLAND DRIVE, WEST ORANGE, NJ, 07052, US

(21) Appl. No.: 10/113,749

(22) Filed: Apr. 1, 2002

(51) Int. Cl. G06F 15/16

(52) U.S. Cl. 709/219

(57) ABSTRACT

A method and apparatus for providing access control and content management services for users and service providers of the Internet is provided. Service providers can upload content to a central server for publication to a plurality of users. URL links within the content are re-directed to point to the central server, and the processed content is transmitted to a user through a single session connecting the user and the central server, for display in a web browser, frame, instance, portal, or portlet on the user's computer. Content responsive to an action taken by the user is provided to the user through the same single session. The central server allows actions of a plurality of users and service providers to be tracked centrally, and allows content from a plurality of service providers to be displayed in the users' web browser without requiring the spawning of a separate browser instance or frame.

### BACKGROUND OF THE INVENTION

1. Field of the Invention

The present invention relates to content management services, and more specifically, to a method and apparatus for providing access control and content management services for service providers and users of the Internet.

2. Related Art

In the era of the Internet, an increasing number of service providers are publishing content over the World Wide Web. In this context, web portals are becoming a preferred framework for offering services to customers, and are displayed in web browsers such as Internet Explorer by Microsoft Corporation and Communicator by Netscape Corporation. Service providers can publish content in portals by creating small windows (“portlets”) within the portal, each of which contain content pertaining to a particular service and published by a service provider. Further, portals allow aggregation of services provided by a variety of service providers by channeling such content through a variety of portlets displayed within a portal. While disparate services may be aggregated in this manner, the infrastructure necessary to provide the content often resides on remote systems hosted by the respective service providers.

A particular problem of existing portal and web browser technologies is the inability to channel content to users without requiring the need to open separate web browser instances or frames. For example, a plurality of portlets can be displayed in a portal active within a web browser instance or frame. When a user clicks on a desired hypertext link within the browser instance, frame, portal, or one or more of the portlets thereof, information provided by a service provider in response to the click must be displayed in a separate instance or frame of the web browser. Thus, users are forced to shift their attention from the currently active browser instance, frame, portal or portlet, to the spawned instance or frame of the web browser generated in response to the user's action. Frequently, separate instances of the web browser are difficult to access because they can become buried beneath other windows currently active in the user's desktop. Accordingly, users can become dissatisfied with the quality of service provided by the service provider, or can unknowingly overlook the content provided in the separate instances and frames.

Previous efforts have been implemented to provide portal services for users of the World Wide Web. For example, the .NET system of Microsoft, the Webtop system of Sun Microsystems, Inc., and the Websphere system by IBM, Inc., provide aggregation of Internet sources stemming from a variety of service providers by channeling content from such services through portals. These systems allow portals and portlets thereof to be connected to specially formatted, site summary pages on remote servers. However, these systems suffer from the above-mentioned shortcomings, because content is returned in response to a user's click through a direct connection provided between a source provider and a spawned instance or frame of the web browser. Additionally, current systems do not allow for centralized tracking of actions taken by users across a variety of service providers; rather, each service provider provides action tracking systems that are only capable of tracking local actions germane to the service provider itself.

What would be desirable, but has not yet been provided, is the ability to aggregate content from a plurality of service providers, channel same through a single session with a user of the Internet, and provide centralized action tracking of user actions across the plurality of service providers. What would also be desirable, but has not yet been provided, is the ability to channel content to users of the Internet in portal and portlet environments without requiring the opening of multiple connections between content providers and the users, and without requiring the spawning multiple instances or frames of web browsers in response to actions of the users.

### OBJECTS AND SUMMARY OF THE INVENTION

It is an object of the present invention to provide a method and apparatus for providing access control and content management services for users and service providers of the Internet.

It is a further object of the present invention to provide a method and apparatus wherein content generated by a plurality of service providers of the Internet can be aggregated and channeled to a user through a single session.

It is another object of the present invention to provide a method and apparatus wherein actions of the user can be centrally tracked across the plurality of service providers.

It is still another object of the present invention to provide a method and apparatus wherein content provided by a service provider in response to a user's action can be channeled to the user without requiring separate instances or frames of the user's browser.

It is an additional object of the present invention to provide a method and apparatus wherein content provided by a service provider in response to a user's action can be channeled through an existing portal or portlet within the user's web browser.

It is a further object of the present invention to provide a method and apparatus wherein dynamic Uniform Resource Locator (URL) re-direction procedures are applied to service provider content to channel content to the user through a single session with the service provider.

It is yet another object of the present invention to provide a central cache for storing content provided by a plurality of service providers and providing same to a user.

It is still another object of the present invention to provide a method and apparatus wherein service providers can selectively modify URL code to allow direct connections between the service provider and a user.

It is a further object of the present invention to provide a method and apparatus wherein content provided by service providers is automatically conformed to World Wide Web Consortium (W3C) standards before transmission to a user.

It is another object of the present invention to provide a method and appartus for providing access control and content management services that can be utilized in both portal and non-portal frameworks.

The present invention relates to a method and apparatus for providing access control and content management service for users and service providers of the Internet. A user can be presented with content from one or more service providers through a single session connecting the user's browser and a central server, and responsive content can be published to the user via the single session. The central server aggregates content from one or more service providers, and applies URL redirection processes to the content so that links of the content pointing to the service providers are re-directed to point to the central server. Optionally, a service provider can specify a direct connection between the user's web browser and the service provider. The central server allows actions of the user to be tracked centrally, across a variety of service providers. The content, once processed, can be displayed in the web browser without requiring the spawning of one or more web browser instances or frames. Additionally, the central server can publish content to the user in a portal environment.

### BRIEF DESCRIPTION OF THE DRAWINGS

These and other important objects, features, and advantages of the invention will be apparent from the following Detailed Description of the Invention, taken in connection with the accompanying drawings, in which:

FIG. 1 is a diagram showing interactions between browser instances or frames and service providers achieved in the prior art.

FIG. 2 is a diagram showing prior art action exchanges and tracking between browser instances or frames and service providers.

FIG. 3 is a diagram showing prior art interactions between a web browser having a portal and associated portlets, a plurality of service providers, and separate web browser instances.

FIG. 4a is a schematic diagram of component parts of the present invention.

FIG. 4b is a diagram showing an alternate embodiment of the present invention operative in as portal environment.

FIG. 5a is a diagram showing an alternate view the present invention including a cache and a central tracking database.

FIG. 5b is a diagram showing an alternate view the present invention including a cache and a central tracking database operative in a portal environment

FIG. 6 is a block diagram showing component parts of the server of the present invention in greater detail.

FIG. 7 is a flowchart showing processing logic of the present invention.

FIG. 8 is a flowchart showing additional processing logic of the present invention.

FIG. 9 is a diagram showing sequences of the present invention for processing URL links embedded within a web page.

FIG. 10 is a diagram showing sequences of the present invention for processing communication between a browser, a server, and at least one service provider.

FIG. 11 is a diagram showing processing sequences of the present invention operative in a portal environment.

### DETAILED DESCRIPTION OF THE INVENTION

The present invention relates to a method and apparatus for providing access control and content management services for users and service providers of the Internet. Content (i.e., web pages) provided by a plurality of service providers is directed to a central server, wherein URL redirection and conforming processes update all URL links within the pages to point to the central server. The content is then published in a single session between a user's web browser and the central server, and subsequent interactions between the user and the server occur within the single session. Content responsive to user actions can be provided to the user's browser, or portals and portlets thereof, without requiring the formation of additional sessions, frames, or instances of the web browser to display the content.

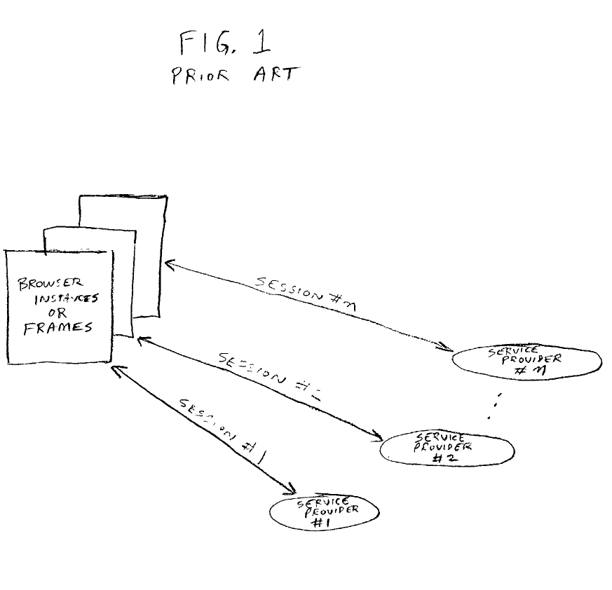

FIG. 1 is a diagram showing interactions between browser instances or frames and service providers achieved in the prior art. As is readily apparent, users of the Internet frequently access the World Wide Web using a web browser. Such web browsers may have multiple instances (i.e., multiple windows of the web browser open at the same time), or multiple frames (i.e., multiple partitions of the browser extant within a single instance). A browser instance establishes communication with a service provider through a session. For each successive instance of the browser, a separate session to a service provider is required. Further, each frame within a given instance of a browser also requires a separate session to communicate with the web browser. Accordingly, the user is presented with content from a variety of service providers using a plurality of browser instances and frames, each of which can clutter the user's web browser and/or desktop and can easily be overlooked by the user.

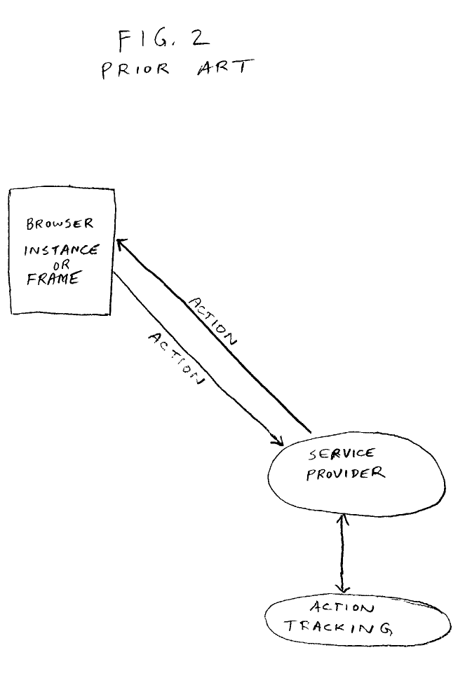

FIG. 2 is a diagram showing the exchange and tracking of actions between a browser instance or frame and a service provider, as is presently achieved in the art. A user can initiate an action, such as clicking on a hypertext link within a page displayed in the browser frame or instance, and the action is then transmitted to the service provider. The service provider may, in response, transmit an action back to the browser, by, for example, loading a new hypertext page into the browser. With this methodology, however, action tracking only occurs at the service provider level. Thus, the service provider can only maintain a database of actions initiated by the user, and log content provided by the service provider in response to the user's action. However, the actions tracked are germane to the service provider, and do not reflect the actions taken by the user with respect to other service providers. Thus, the service provider is limited to providing local action tracking, and cannot provide centralized action tracking across a variety of service providers.

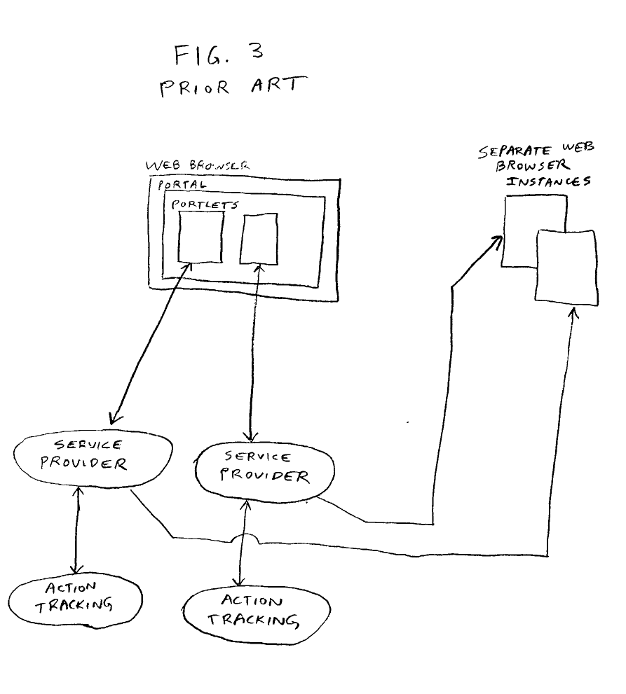

FIG. 3 is a diagram showing interactions between a web browser having a portal and associated portlets, a plurality of service providers, and separate web browser instances as is known in the art. A web portal is provided in the user's web browser for accessing information originating from a variety of disparate service providers. A service provider can transmit content into the web portal through a session connected to a portlet and displayed within the portal. Each portlet requires a separate session with each respective service provider. Further, as described for FIG. 2, each service provider can provide local action tracking of actions exchanged between a user via a portlet and the service provider, but cannot provide centralized action tracking. Once the content is displayed in the portlet, a user can click on a link within the portlet. However, in response to the click, the service provider cannot channel information back into the portlet in which the user clicked. Rather, as is shown in the diagram, the service provider publishes responsive content in a separate instance or frame spawned by the user's web browser. Thus, the aforementioned problem of inundating the user with numerous browser instances or frames is left unremedied. Further, multiple sessions must be opened between the user's browser (including all frames, instances, portals, and portlets associated therewith) and the disparate service providers.

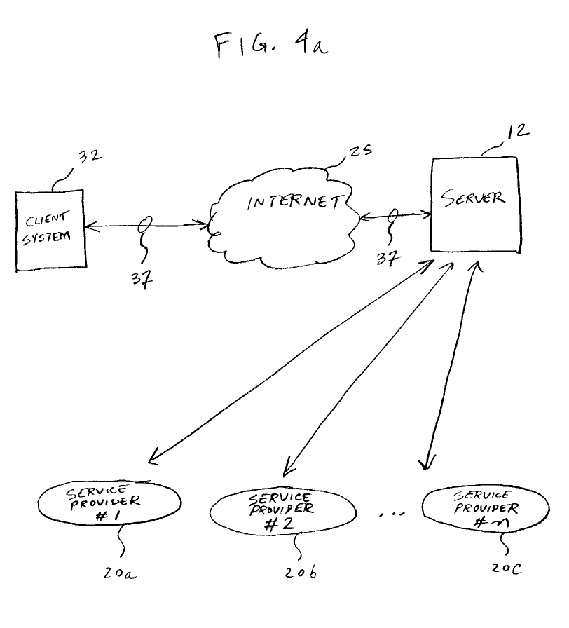

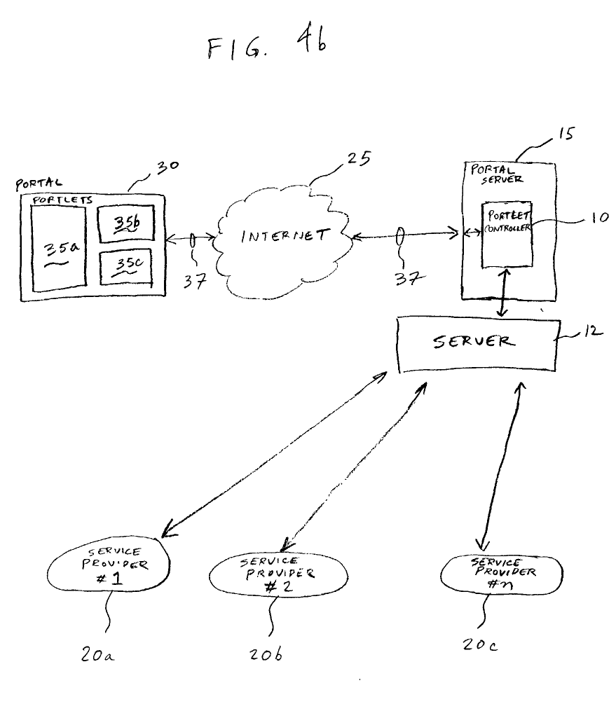

FIG. 4a is a schematic diagram showing component parts of the system of the present invention. The present invention overcomes the aforementioned limitations of current web browser and portal technology by allowing a plurality of service providers to communicate with a user over a single session between the user's system and a central server. Further, the invention allows service providers to publish content in existing instances, frames, portals, or portlets of the user's browser, thereby obviating the need to spawn additional instances, frames, portals, or portlets thereof.

Initially provided are a plurality of service providers, illustratively indicated as service providers 20a-20c, each of which desire to publish content in the form of hypertext markup language (HTML) pages, extensible markup language (XML) pages, and other page formats known in the art. Each of service providers 20a-20c submits the content to central server 12 via a network connection or through the Internet. Central server 12 then aggregates the content provided by service providers 20a-20c, and applies URL redirection processes, W3C conformation processes, and other processing logic to the content. Then, a single session 37 is established between client system 32 and server 12 using the Internet 25. It is to be understood that session 37 can be established over any networking methodology or architecture presently known in the art.

Client system 32 contains a web browser accessed by a user, to which the formatted and processed content provided by central server 12 is directed. Importantly, the processing logic of server 12, described in greater detail below, allows for the publication of content originating from service providers 20a-20c through single session 37, and further allows a user to access information from the service providers 20a-20c using a single web browser instance, frame, portal, or portlet. Further, server 12 allows for centralized tracking of a user's actions occurring between each of service providers 20a-20c. Additionally, when a user requests access to a given link for a particular service provider, the request is transmitted from client system 32 across single session 37, received by server 12, and the appropriate connection is established by server 12 to the desired service provider. Then, content in response to the request and furnished by the service provider is forwarded back to server 12, whereupon it is formatted using the aforementioned processing techniques, and sent back to client system 32 across Internet 25 through single session 37.

FIG. 4b is a diagram showing the system of the present invention adapted for operation in al portal environment. As depicted and described for FIG. 4a, a plurality of service providers 20a-20c are in communication with server 12 using the Internet or other known networking methodology. Content originating therefrom is aggregated and processed by server 12 using the same processing, URL redirection, and conformation procedures as described for FIG. 4a. However, rather than transmitting the processed content directly to a web browser of a client's machine, the processed content is forwarded to a portal server 15. Portal server 15 can be any server known in the art that is capable of providing portal services for users of the World Wide Web.

Included in portal server 15 is a portlet controller 10. Portlet controller 10 is responsible for interfacing with server 12, and applies portlet frame formatting and processing operations to the content so that it is suitable for presentation within one or more portlets of portal 30, illustratively indicated as portlets 35a-35c. Once formatted and processed by portlet controller 10, the content is then forwarded to portal server 15 for transmission across Internet 25 and session 37 to a portal 30 of a user's web browser. Importantly, by channeling content from service providers 20a-20c and processing same using URL redirection techniques, server 12 ensures that the content is displayed in one or more portlets 35a-35c of portal 30 without requiring the need to spawn additional portals when an action is taken by the user.

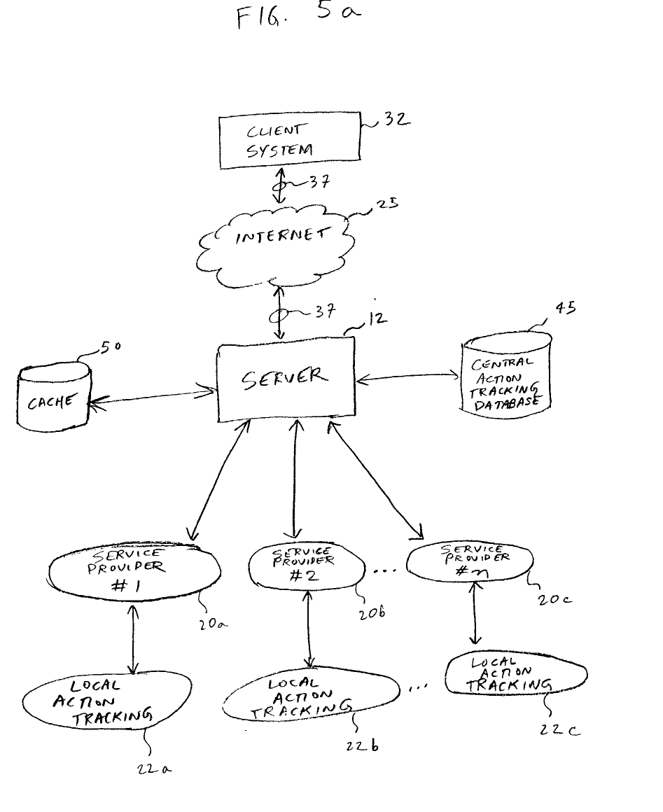

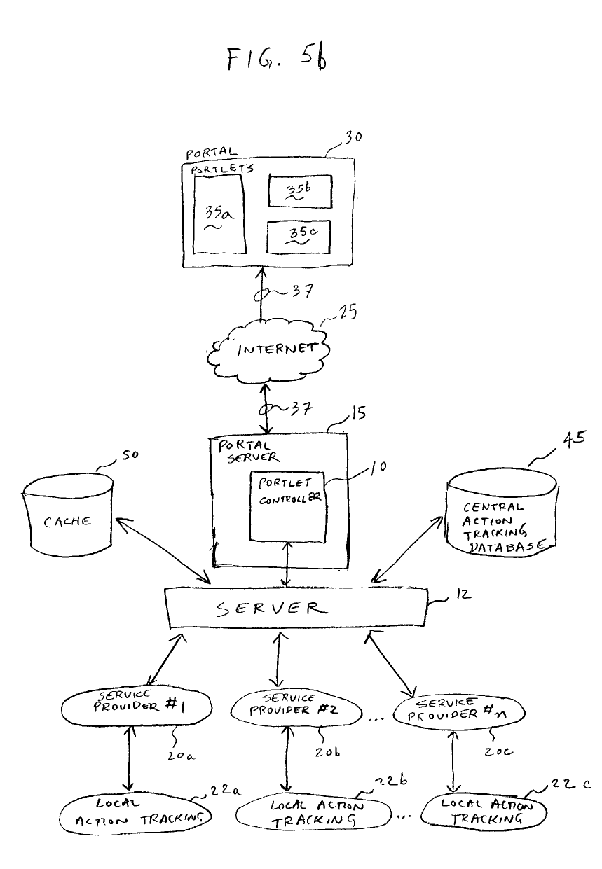

FIG. 5a is a schematic diagram showing an alternate embodiment of the present invention, wherein central cache and action tracking services are provided. As discussed earlier, a plurality of service providers 20a-20c can submit content to server 12, wherein said content is processed for transmission to client system 32 via Internet 25 and session 37. Service providers 20a-20c have the ability to provide systems, illustratively indicated as systems 22a-22c, for locally tracking actions received by the respective service providers 20a-20c from client system 32, and conversely, for locally tracking actions generated by the respective service providers 20a-20c and transmitted to client system 32. Importantly, server 12 provides centralized action tracking services, so that actions taken by client system 32, and actions responsive thereto, are tracked across a plurality of service providers 20a-20c. For example, user page requests and browsing can be tracked, and workflow analysis generated therefrom. Further, financial systems can be integrated with server 12 for generating usage bills based upon the tracked information. The information tracked by server 12 is stored in central action tracking database 45.

Also connected to server 12 is cache 50. Cache 50 allows the service providers 20a-20c to enhance system performance and reduce bandwidth requirements by storing frequently accessed content, such as forms requesting data from users, embedded image links, and image files, for access by users via server 12. Optionally, service providers 20a-20c can embed URL directives in their content to force some or all of the content to be retrieved from service providers 20a-20c and not from cache 50, thereby bypassing same. Thus, by storing frequently accessed information in cache 50, service providers can reduce traffic and bandwidth requirements of their respective equipment. In a preferred embodiment of the present invention, both cache 50 and central action tracking database 45 have sufficiently large storage capacities to allow numerous cache requests and actions to be processed. Further, it is to be understood that any relational database management systems known in the art can be used with cache 50 and central action tracking database 45.

FIG. 5b is a schematic diagram of the present invention, wherein cache and central action tracking services are provided in a portal environment. A plurality of service providers 20a-20c, each having respective local action tracking systems 22a-22c, are in communication with server 12 and submit content thereto for processing. Cache 50 and central action tracking database 45 provide additional services for the service providers 20a-20c , allowing frequently accessed content provided by the service providers 20a-20c to be stored in cache 50, and further allowing actions exchanged between a user and the service providers 20a-20c to be logged in central action tracking database 45. Upon processing the content (i.e., providing URL redirection, formatting, and conformation procedures to the content), server 12 then submits the content to portlet controller 10 of portal server 15. Portlet controller 10 applies portlet frame formatting and customization procedures to the content so that same can be displayed in one or more portlets 35a-35c of a portal 30 of a user's web browser. Once formatted and customized, the content is sent from portlet controller 10 to portal server 15, for transmission over the Internet 25 and session 37 to a user's browser. It is to be understood that portal server 15 can be any system known in the art that is capable of providing web portal services.

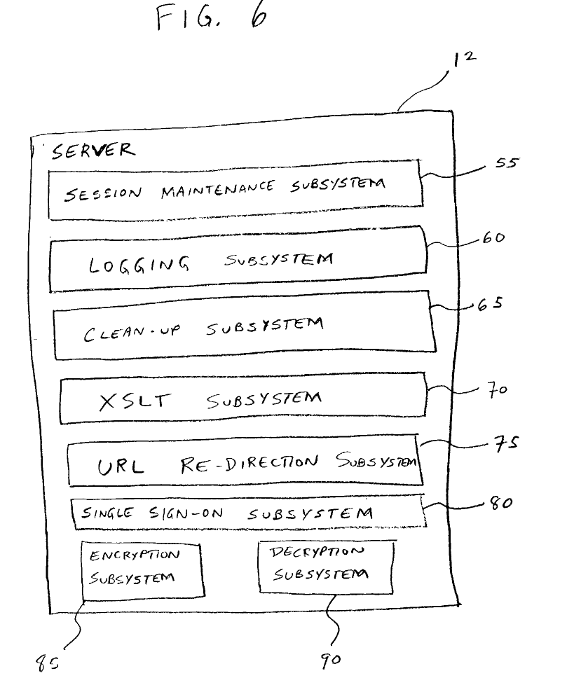

FIG. 6 is a block diagram showing component parts of server 12 of the present invention. Server 12 can be any general purpose computer system known in the art, running any operating system known in the art, such as Solaris® by Sun Microsystems, Inc. Further, in a preferred embodiment of the present invention, server 12 contains sufficient memory, disk, and processing resources to handle a plurality of user and service provider processes simultaneously. Server 12 comprises a plurality of subsystems, each of which are responsible for handling specific tasks which, in combination, provide the services of the present invention.

Session maintenance subsystem 55 is responsible for managing and maintaining connections with one or more service providers. Header information transmitted from and received by each of the service providers is stored and managed by this subsystem. A single user can be identified across a variety of service providers using a session identifier that is passed by session maintenance subsystem 55 to the user's browser, or by encrypting the session identifier into the URL links of the content pages.

Logging subsystem 60 provides centralized tracking of actions by users and one or more service providers, and interacts with central action tracking database 45. Further, logging subsystem 60 can track all information passed to portal server 15 and portlet controller 10. Logging subsystem 60 can be configured to store all actions between users and service providers, or, optionally, a subset thereof, so that storage space and system resources are conserved. to Clean-up subsystem 65 conforms content provided by the service providers to accepted World Wide Web Consortium (W3C) standards, and ensures that all HTML and XML content is well-formed. The content received by clean-up subsystem 65 is automatically parsed and modified to match W3C standards. This feature allows the present invention to operate reliably with web browsers of different manufacture, thereby increasing the quality of content received by users.

XSLT subsystem 70 processes all Extensible Markup Language (XML) content provided by the service providers. XML pages contain only raw data, and are not, of themselves, capable of display within a web browser. Thus, Extensible Stylesheet Language (XSL) pages are applied to XML data in order to provide a desired structure and format for the raw XML data, thus allowing display within the web browser. XSLT subsystem 70 obviates the need for service providers to generate and apply their own XSL stylesheets by dynamically applying pre-defined stylesheets to raw XML data provided by the service provider. Thus, XSLT subsystem 70 reduces the work necessary by service providers by automatically applying XSL stylesheets to the service provider's raw XML data, thereby allowing the data to be presented in customizable pages for view in web browsers. It is to be understood that the service providers can customize the pre-defined XSL stylesheets utilized by XSLT subsystem 70, or generate their own for use thereby.

URL redirection subsystem 75 is responsible for ensuring that all URL links within the content provided by the service providers are modified to point back to server 12. This URL re-direction technique thereby allows a single session to exist between a user and server 12, because all traffic occurring between the service providers and users is channeled through server 12. URL redirection subsystem 75 scans and modifies all pages generated by the service providers, and modifies same so that URL links thereof do not re-direct the user directly to the service providers. Optionally, a service provider 75 can over-ride URL redirection subsystem 75, so that occasional direct links between the service provider and users are allowed. Accordingly, the service providers are afforded a degree of control over the content they provide, and can request direct connections as security, performance, and policy needs dictate.

Single sign-on subsystem 80 allows a user to communicate with a plurality of service providers without having to identify him or herself (i.e., via a login or password) multiple times. A single piece of information identifying a user is passed to the service providers by subsystem 80. A user can access personally-tailored information from a variety of service provider systems without having to re-log on to each successive system. Subsystem 80 can further maintain information relating to the user's preferred topics of interest, address information, languages spoken, and phone numbers.

Encryption subsystem 85 receives URLs processed by URL redirection subsystem 75 and encrypts same into random strings of information, providing numerous benefits to the service providers. For example, existing portal servers are provided with increased customer retention rates, because the actual identity of services providers are hidden. Further, confidential information passed between service providers and users is secured, and the cumbersome number and symbols that are traditionally associated with URL and which disrupt portal service, are removed.

When an action of a user is received by server 12, decryption subsystem 90 extracts encrypted random strings from the user's action, and decrypts same into a URL pointing to a given service provider. Then, server 12 can communicate with the specified service provider to acquire content specified by the URL.

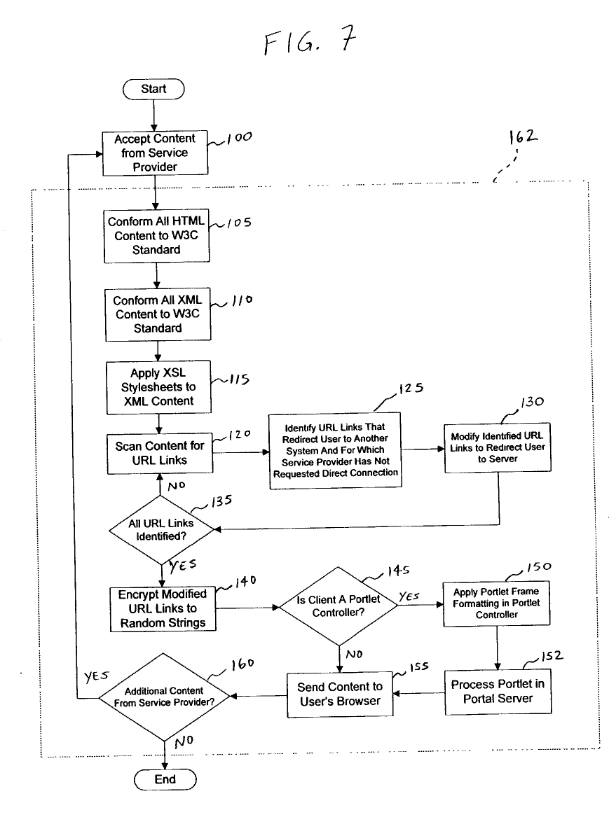

FIG. 7 is a flowchart showing processing logic of the present invention. Beginning in step, 100, content from a service provider is accepted by server 12 of the present invention. Such content can be HTML pages, XML pages, or other page formats known in the art. Then, in step 105, the HTML contents are conformed to W3C standards for HTML, so that the HTML content is well-formed and capable of display in web browsers of different manufacture. Once the HTML content has been conformed to W3C standards, step 110 is invoked, wherein all XML content is conformed to W3C standards for XML. In step 115, Extensible Stylesheet Language (XSL) stylesheets are applied to the XML content, so that same can be rendered according to a desired layout or configuration. The XSL stylesheets can be pre-defined by the service providers or can be custom-designed and loaded with the XML content. In a preferred embodiment of the present invention, the applied XSL stylesheet is selected from a library of pre-defined stylesheets that are frequently used by one or more service providers.

Once the HTML and XML content have been conformed, and XSL stylesheets applied, the content is then scanned in step 120 so that all URL links in the content are identified. Then, in step 125, all URL links that re-direct users to another system, and for which the service provider has not requested a direct connection, are identified. For example, if a URL link within a service provider's content is a directive to a user's browser to establish a connection with the same or another service provider for additional content, the URL link is identified in step 125 for modification. Once the URL links have been identified, step 130 is invoked, wherein the identified URL links are modified to re-direct the user's browser to server 12.

In step 135, a determination is made as to whether all URL links in the service provider's content have been identified and processed in the manner described above. If a negative determination has been made, step 135 re-invokes step 120, so that additional URL links can be identified and processed. If a positive determination is made, step 135 invokes step 140.

In step 140, all of the modified URLs (i.e., the URLs that have been identified and re-directed by steps 125 and 130) are encrypted into random strings. Then, in step 145, a determination is made as to whether the client system to which the content is to be sent is a portlet controller (i.e., portlet controller 10). If a positive determination is made, step 145 invokes step 150. If a negative determination is made, step 145 invokes step 155, wherein the content is sent directly to a user's web browser for display.

In the event that step 150 is invoked by step 145, a determination has been made that the client system is a portlet controller. Accordingly, portlet frame formatting procedures are applied to the content, to render same suitable for display in a portal environment at the client system. Then, step 152 is invoked, wherein the portlet is transmitted to a portal server for processing. In step 155, the portal is sent to a user's browser for display within a portal environment. In step 160, a determination is made as to whether additional content from the service provider exists. If so, step 100 is re-invoked, so that the aforementioned processing logic can be applied to the content. If a negative determination is made, processing of the service provider's content is complete.

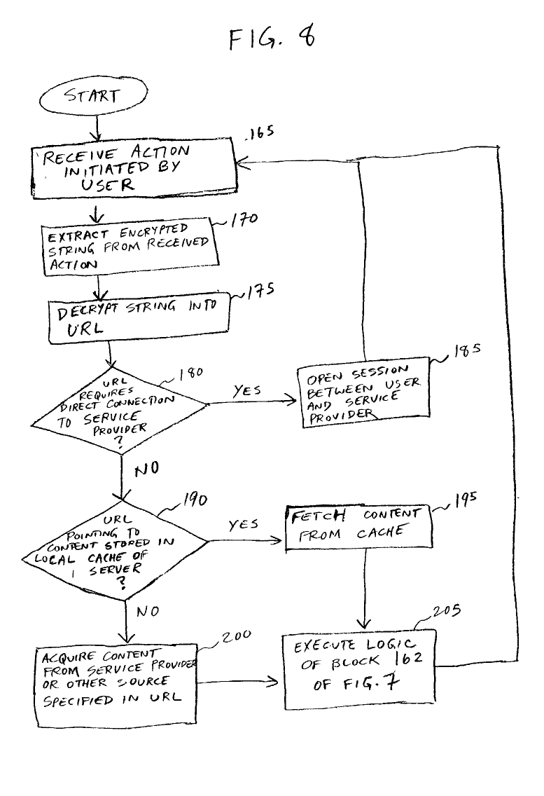

FIG. 8 is a flowchart showing additional processing logic of the present invention, wherein actions taken by a user in response to content published in either a web browser or portal or portlet thereof are received by the present invention and processed. Beginning in step 165, an action initiated by a user, such as a click on a hypertext link within a browser or portlet page, is received by server 12 of the present invention. In step 170, an encrypted string is extracted from the received action, the encrypted string being generated in a previous session using the processing logic of FIG. 7. Then, in step 175, the string is decrypted into a URL specifying content residing on one or more service provider systems. A decision point is reached in step 180, wherein a determination is made as to whether the URL requires a direct connection between the user's web browser, portal, or page, and a service provider system. If a positive determination is made, step 185 is invoked, wherein a session corresponding to a direct connection is opened between the user and the service provider. Then, step 165 is re-invoked so that additional actions can be received and processed by server 12.

In the event that a negative determination is made in step 180, step 190 is invoked, wherein a second determination is made. If the URL points to content stored in the cache 50 of server 12, step 195 is invoked, wherein the content is fetched from cache 50. Then, step 195 invokes step 205, wherein the processing logic of block 162 of FIG. 7 is invoked, so that the content fetched from cache 50 can be processed according to the logic described therein. Once the content is processed by step 205, step 165 is re-invoked, so that additional actions can be received and processed by server 12.

In the event that a negative determination is made in step 190, step 200 is invoked. In step 200, content specified in the URL is acquired from one or more service providers or other sources. Then, step 205 is invoked, wherein the processing logic of block 162 of FIG. 7 is invoked, so that the content specified by the URL is processed according to the logic described therein. Once the content has been so processed, step 165 is invoked, so that additional user actions can be received and processed by server 12.

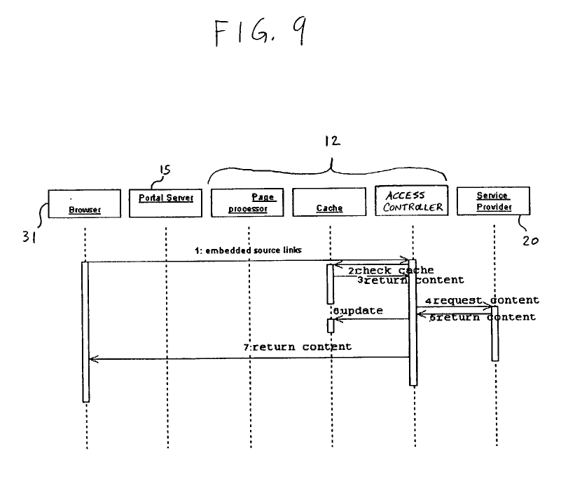

FIG. 9 is a diagram showing sequences achieved by the present invention for processing embedded links within a service provider's content, such as an HTML or XML page. In step 1, content having embedded source links and originating from browser 31 is passed to an access controller (i.e., session maintenance subsystem 55 of FIG. 6) of server 12. Then, in step 2, a check is performed in the cache of server 12, and a determination is made as to whether the content specified by the embedded links is stored therein. If so, in step 3, the content is returned from the cache to the access controller of server 12. Alternatively, if the content specified by the embedded links does not exist in the cache, the specified content is requested in step 4 from service provider 20. The content is then returned in step 5 from service provider 20 to the access controller of server 12. Further, once the specified content has been retrieved from service provider 20, a copy of the content is made by access controller 12 and passed to the cache of server 12 in update step 6, thereby allowing future queries for content to be satisfied by the cache of server 12 and obviating the need to query one or more service providers. Such a feature reduces bandwidth requirements of the one or more service providers, and allows content to be quickly and efficiently provided in response to a request specified by the embedded links. Finally, in step 7, the content is passed back to the user's browser 31. Optionally the returned content can be passed to portal server 15, for presentation to the user in a portal framework.

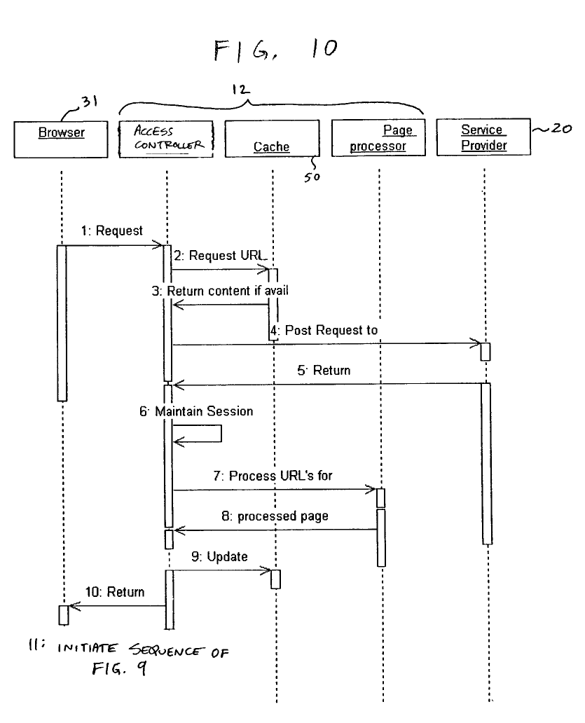

FIG. 10 is a diagram showing overall processing sequences of the present invention, occurring between a client browser and one or more service providers. In step 1, a user request (action) originating from browser 31 is received by an access controller (i.e., session maintenance subsystem 55) of server 12. Then, in step 2, a URL request is transferred from the 20 access controller to cache 50 of server 12, and a determination is made as to whether the content specified in the URL request exists in cache 50. If the content is available in cache 50, the content is returned in step 3 to the access controller of server 12. If the content is not available in cache 50, step 4 posts the URL request to a service provider 20. The requested content is then sent back to the access controller of server 12 from the service provider 20 in step 5.

Once the requested content has been provided to the access controller, either by cache 50 or the service provider 20, the access controller maintains a session with the user's browser 31 in step 6. Then, in step 7, the URL's of the requested content are processed by the page processor (collectively, the clean-up subsystem 65, XSLT subsystem 70, URL re-direction subsystem 75, encryption subsystem 85, and decryption subsystem 90) of server 12. Once processed, the requested content is sent back to the access controller of server 12 in step 8. Optionally, in step 9, the cache 50 of server 12 can be updated with the processed content, so that future requests for the content can be provided by cache 50 as opposed to one or more service providers. In step 10, the processed content is then sent to the browser 31 for display in either a web page, portal, or portlet. In step 11, the sequence of FIG. 9 is initiated, so that embedded links within pages can be processed.

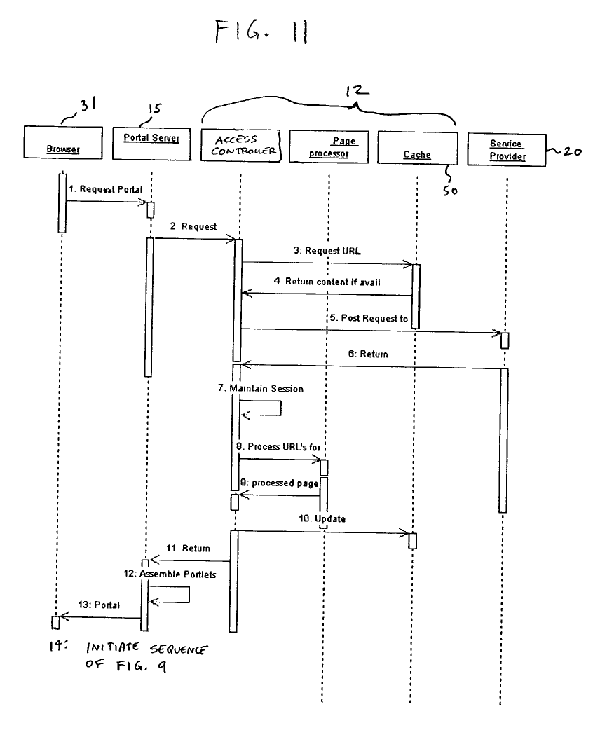

FIG. 11 is a diagram showing overall processing sequences of the present invention, installed in a portal environment. In step 1, a portal request originating from a user's browser 31 is received by portal server 15. The request is then transferred to the access controller of server 12 in step 2. In step 3, the URL requesting content is passed to cache 50 to determine whether the requested content exists therein. If the requested content is available, it is retrieved by cache 20 50 and passed back to the access controller in step 4. Otherwise, if the content is unavailable in cache 50, the request is passed to a service provider 20. Then, the requested content is returned from the service provider 20 to the access controller in step 6.

Once the requested content has been retrieved in either cache 50 or from service provider 20, in step 7, a session is maintained between the browser 31 and the access controller. In step 8, the URLs within the requested content are processed by the page processor (collectively, the clean-up subsystem 65, XSLT subsystem 70, URL re-direction subsystem 75, encryption subsystem 85, and decryption subsystem 90) of server 12. Once processed, the content is then returned from the page processor to the access controller in step 9. Optionally, in step 10, the processed content can be loaded into cache 50 for future retrieval. In step 11, the content is returned to the portal server 15, where it is then assembled into portlets by step 12. In step 13, the assembled portlets are transferred within a portal from the portal server 15 to the user's web browser 31. Finally, in step 14, the sequence of FIG. 9 is initiated so that embedded links within the content can be processed.

Having thus described the invention in detail, it is to be understood that the foregoing description is not intended to limit the spirit and scope thereof. What is desired to be protected by Letters Patent is set forth in the appended claims.

What is claimed is:

1. A method for providing access control and content management services for a plurality of service providers comprising:
accepting content from the plurality of service providers at a server;
modifying one or more UTRL links of the content to point to the server; and
transmitting the content to a user through a single session connected between a user and the server.

2. The method of claim 1, wherein the step of accepting content from the plurality of service providers comprises accepting HTML pages at the server from the plurality of service providers.

3. The method of claim 2, further comprising automatically conforming the HTML pages to W3C standards prior to modifying the one or more URL links.

4. The method of claim 1, wherein the step of accepting content from the plurality of service providers comprises accepting XML pages at the server from the plurality of service providers.

5. The method of claim 4, further comprising automatically conforming the XML pages to W3C standards prior to modifying the one or more URL links.

6. The method of claim 5, further comprising applying XSL stylesheets to the XML pages prior to modifying the one or more URL links.

7. The method of claim 1, wherein the step of modifying the one or more URL links further comprises encrypting the one or more URL links into random strings.

8. The method of claim 1, wherein the step of transmitting the content to the user comprises transmitting the content to a web browser located at the user.

9. The method of claim 1, wherein the step of transmitting the content to the user comprises:
transmitting the content to a portal server;
formatting the content into portlets; and
displaying the portlets in a portal of a web browser.

10. The method of claim 1, wherein the step of modifying the one or more URL links comprises optionally allowing at least one URL link to specify a direct connection between a user's web browser and at least one of the service providers.

11. The method of claim 1, further comprising tracking actions of the user centrally at the server.

12. A method of providing interactive web browsing for a user comprising:
establishing a single session between a central server and a web browser located at the user;
publishing content from the central server through the single session for display in the web browser, the content originating from one or more service providers connected to the central server;
allowing the user to initiate an action in the web browser in response to the content; and
publishing responsive content from the central server through the single session for display in the web browser, the responsive content originating from the one or more service providers.

13. The method of claim 12, further comprising modifying URL links of the content to point to the central server prior to publishing the content.

14. The method of claim 13, further comprising encrypting the URL links prior to publishing the content.

15. The method of claim 14, wherein the step of allowing the user to initiate the action comprises allowing the user to click on one or more of the UTRL links.

16. The method of claim 14, further comprising decrypting the URL link at the central server prior to publishing the responsive content.

17. The method of claim 16, further comprising retrieving the responsive content from at least one service provider indicated in the URL link prior to publishing the responsive content.

18. The method of claim 12, wherein the step of publishing the content comprises displaying the content in a frame of the web browser.

19. The method of claim 12, wherein the step of publishing the content comprises displaying the content in an instance of the web browser.

20. The method of claim 12, wherein the step of publishing the content comprises displaying the content in a portlet of the web browser.

21. The method of claim 12, wherein the step of publishing the responsive content comprises displaying the responsive content in an existing instance of the web browser.

22. The method of claim 12, wherein the step of publishing the responsive content comprises displaying the responsive content in an existing frame of the web browser.

23. The method of claim 12, wherein the step of publishing the responsive content comprises displaying the responsive content in an existing portlet of the web browser.

24. The method of claim 12, further comprising retrieving the content from a cache at the central server prior to publishing the content.

25. The method of claim 12, further comprising retrieving the responsive content from a cache at the central server prior to publishing the responsive content.

26. The method of claim 12, further comprising optionally establishing a direct session between the web browser and the one or more service providers.

27. An apparatus for providing access control and content management services for one or more service providers comprising:
a central server;
means at said central server for receiving content from the one or more service providers;
means for modifying at least one URL link of the content to point to the central server;
a single session connected between a web browser of a user and the central server; and
means for transmitting the content to the user through the single session.

28. The apparatus of claim 27, wherein the means for receiving content further comprises means for receiving HTML pages from the one or more service providers.

29. The apparatus of claim 28, further comprising means for conforming the HTML pages to W3C standards.

30. The apparatus of claim 27, wherein the means for receiving content further comprises means for receiving XML pages from the one or more service providers.

31. The apparatus of claim 30, further comprising means for conforming the XML pages to W3C standards.

32. The apparatus of claim 30, further comprising means for applying XSL stylesheets to the XML pages.

33. The apparatus of claim 27, further comprising means for encrypting the at least one URL link into a random string.

34. The apparatus of claim 27, further comprising a portal server for formatting the content into one or more portlets.

35. The apparatus of claim 34, further comprising means for transmitting the one or more portlets to the web browser.

36. The apparatus of claim 27, further comprising means for optionally establishing at least one direct connection between the one or more service providers and the web browser.

37. The apparatus of claim 27, further comprising means for tracking actions of the user at the central server.

38. The apparatus of claim 27, further comprising a cache at the central server for transmitting content to the web browser.

39. An apparatus for providing interactive web browsing comprising:
a central server;
means at said central server for establishing a single session between a web browser of a user and the central server;
means for publishing content through the single session to the web browser of the user, the content originating from one or more service providers connected to the central server;
means for detecting an action initiated in the web browser in response to the content; and
means for publishing responsive content through the single session to the web browser of the user, the responsive content originating from the one or more service providers.

40. The apparatus of claim 39, further comprising means for modifying URL links of the content to point to the central server.

41. The apparatus of claim 40, further comprising means for encrypting the URL links into random strings.

42. The apparatus of claim 40, further comprising means for decrypting the URL links at the central server.

43. The apparatus of claim 40, further comprising means for retrieving the responsive content from at least one service provider indicated in the URL link.

44. The apparatus of claim 39, further comprising means for displaying the content in a frame of the web browser.

45. The apparatus of claim 39, further comprising means for displaying the content in an instance of the web browser.

46. The apparatus of claim 39, further comprising means for displaying the content in a portlet of the web browser.

47. The apparatus of claim 39, further comprising means for displaying the responsive content in an existing instance of the web browser.

48. The apparatus of claim 39, further comprising means for displaying the responsive content in an existing frame of the web browser.

49. The apparatus of claim 39, further comprising means for displaying the responsive content in an existing portlet of the web browser.

50. The apparatus of claim 39, further comprising a cache at the central server for providing content to the web browser.

51. The apparatus of claim 39, further comprising means for establishing a direct connection between the one or more service providers and the web browser.

52. The apparatus of claim 39, further comprising means at the central server for centrally tracking actions of one or more users.
